(19) United States
(12) Patent Application Publication
(10) Pub. No.: US 2009/0173586 A1
(43) Pub. Date: Jul. 9, 2009

(54) Safety brake

(76) Inventors: Herbert Seeger, Bad Oeynhausen (DE); Udo Meller, Wermelskirchen (DE)

Correspondence Address: Sott R Foster;Padiscio & Pandscio, 470 Totten Pond Road, Waltham, MA, 02451, US

(21) Appl. No.: 11/659,304

(22) PCT Filed: Aug. 3, 2005
(86) PCT No.: PCT/EP05/08417

§ 371 Date: Dec. 5, 2008

(30) Foreign Application Priority Data
Aug. 4, 2004 (DE) 10 2004 038 022.8

(51) Int. Cl. F16D 65/36

(52) U.S. Cl. 188/156; 188/72.1

(57) ABSTRACT

The present invention concerns a safety brake (1) that is hydraulically/pneumatically actuated.

The booster system (7) necessary for this purpose is composed of a hydraulically driven piston-cylinder system (8) and a modulatable, motorically driven hydraulic system arranged in parallel therewith.

The present invention concerns a safety brake according to the preamble of the main claim.

Such safety brakes are used in mechanical engineering to brake known loads to a stop. In a beginning braking process, the still-moving load that is to be braked absolutely must come to a stop, since otherwise the safety function of the safety brake would not be achieved.

The load torque—with superimposed external forces—produced by the moving load is opposite in direction to the braking torque developed between the brake rotor and the brake stator. The braking torque therefore continuously causes the kinetic energy induced by the load torque to be eliminated altogether. The safety brake is then in the “brake applied” position, in which there is no longer any dynamic friction between the brake rotor and the brake stator, but only static friction.

Such safety brakes are known for example as spring-actuated brakes, which are actuated by means of a pressure medium.

The springs function in this case as power boosters, which may be assisted still further in their dynamic effect by hydraulic components.

However, the operation of these power boosters is cancelled out, in any event, by the piston-cylinder unit when the pressure medium flows into the piston-cylinder unit during the charging process, so that the safety brake is then shifted back into its “brake released” position.

The braking function introduced by the spring force therefore works against the pressure medium that is routed into the piston-cylinder unit to re-release the safety brake.

Alternatives to these passive brakes are active brakes, in which braking function is brought about by means of a hydraulic or pneumatic pressure medium in addition to or instead of spring actuation.

Without limiting the invention, brakes based on the reverse principle may also be contemplated. This is understood to mean that the brakes are shifted into the brake released position by the power booster, whereas they are forced into the brake applied position by the pressure medium.

The following embodiments therefore apply correspondingly to all the different types of brakes cited above.

Thus, without limiting the invention hereto, only spring-force-actuated, pressure-medium-released brakes will be discussed hereinafter, unless necessary variations for other types of brakes are expressly indicated.

Such safety brakes serve for example in mechanical engineering to decelerate loads for example in escalators, presses, conveyor belts or the like. They are distinguished by the fact that in the operating range between the brake released position and the brake applied position, the rotation speed of the brake rotor decreases continuously to a stop.

Only dynamic friction is present between the brake rotor and the brake stator during this continuous decrease in rotation speed; this ultimately gives way to static friction when the brake applied position is assumed. The load is then held stationary until the brake is charged with pressure medium.

It should be noted for the sake of completeness that both hydraulic and pneumatic pressure media may be contemplated as the pressure medium.

In such spring-actuated brakes, the braking torque is dictated in practice by the spring forces that are applied. This also applies mutatis mutandis to other types of power boosters.

However, the fact that the braking torque depends solely on the nature of the power booster is felt to be a disadvantage for example if the braking action is to take place load-dependently or for example has to be tracked to monitor wear.

Escalators provide one example of a practical application.

An escalator that is carrying only a few people should be decelerated in an emergency situation slowly enough so that there is no risk of injury to the passengers, even though the safety brake is designed for the high braking torque of an escalator that is filled to capacity.

In addition, however, the high braking torque must also be reached when, due to high wear on the brake pad, the spring forces from the power booster must travel farther to reach the brake applied position than would be the case with a brake pad that was in new condition.

It is therefore an object of the present invention to improve the known safety brake such that a hydraulically or pneumatically controllable system of great sensitivity is obtained with little constructional expenditure.

The invention achieves this object by means of the features of the main claim.

The invention produces the advantage that the sensitivity of the hydraulic or pneumatic control is improved.

This advantage is achieved by the fact that the booster system is divided into two piston-cylinder units, of which the one piston-cylinder unit is driven solely hydraulically or pneumatically and is designed to shift the brake components from the brake applied position to the brake released position and vice versa, whereas an additional piston-cylinder unit, which is also a component of the booster system but is of smaller structural size, is provided to be responsible for modulating the operating pressures within the operating range of the safety brake between the brake released position and the brake applied position.

This structurally smaller system of the additional piston-cylinder unit not only has smaller moving masses, but also exhibits lower breakaway torques between the piston and the cylinder, so that not only the reaction times, but also the reaction speeds of the additional piston-cylinder unit are more sensitive from a control engineering standpoint than the hydraulically driven piston-cylinder unit.

This advantage is achieved by the fact that both the additional piston-cylinder unit and the hydraulically driven piston-cylinder unit, which ultimately serves only to activate and deactivate the brake, are connected in parallel to the common pressure medium line that feeds the piston-cylinder unit serving to shift the safety brake between the brake applied position and the brake released position.

Three piston-cylinder units thus are provided, only the first of which serves to shift the safety brake from the brake applied position to the brake released position and has a direct effect on the relative position between the brake rotor and the brake stator.

The hydraulically driven piston-cylinder unit serves to force pressure medium into and out of the first piston-cylinder unit. According to the invention, the additional piston-cylinder unit is arranged in parallel with the hydraulically driven piston-cylinder unit, and on the one hand is also connected by its hydraulic side, in parallel with the hydraulically driven piston-cylinder unit, to the pressure medium line, and on the other hand is connected on its side facing away from the hydraulic side to a displacing drive.

Said displacing drive assumes the function of stably positioning the additional piston-cylinder unit in different positions.

To this end, the displacing drive is motorically implemented and acts on the additional piston-cylinder unit in the sense that the latter is stably positioned in different positions.

If a compression spring is disposed between the displacing drive and the additional piston-cylinder unit, then simple closed-loop control operations can also be executed by the additional piston-cylinder unit.

It is additionally proposed that at least one measuring sensor be provided to detect an operating parameter, said sensor being integrated into a feedback control loop for modulating the displacing drive.

It is useful in this regard if the static pressure in the pressure medium line is detected and used to modulate the displacing drive.

Complementarily hereto, additional measuring sensors can also be provided which are used in the detection of additional operating parameters, for example the loads to be braked or the like.

The compression spring is usefully dimensioned such that when the pressure in the pressure line is lower than the pressure necessary to shift the piston-cylinder unit in the direction of the brake released position, the inventive additional piston-cylinder unit is held in resiliently supported suspension, so that a slight right/left deflection is possible between the piston and the cylinder of the additional piston-cylinder unit in dependence on the operating parameter variations that inevitably occur during operation. The compression spring should also, however, be dimensioned with respect to the geometric dimensions of the additional piston-cylinder unit such that it can be compressed, under the pressure necessary to shift the piston-cylinder unit in the direction of the brake released position, to such an extent that the inventive additional piston-cylinder unit then butts against the rear stop, that is, the compression spring then reaches its maximum tension.

This can occur for example as a result of the compression spring being compressed with its coils in mutual contact or as a result of the piston of the additional piston-cylinder unit abutting a housing-side stop of the associated cylinder.

The additional piston-cylinder unit usefully has only one hydraulic side.

On its side facing away from the hydraulic side, it is acted upon mechanically.

For this purpose, it is proposed to use an electric drive that acts on the additional piston-cylinder unit via an adjusting spindle.

Such adjusting spindles are components of commercially available spindle servomotors, which are driven purely electrically and therefore permit a high reaction speed.

To this end, it is complementarily proposed to place between the respectively used measuring sensors and the motor controller suitable converters that output an electrical signal corresponding to the respective measured value of the operating parameter.

The invention is explained in further detail below on the basis of an exemplary embodiment. In the drawing:

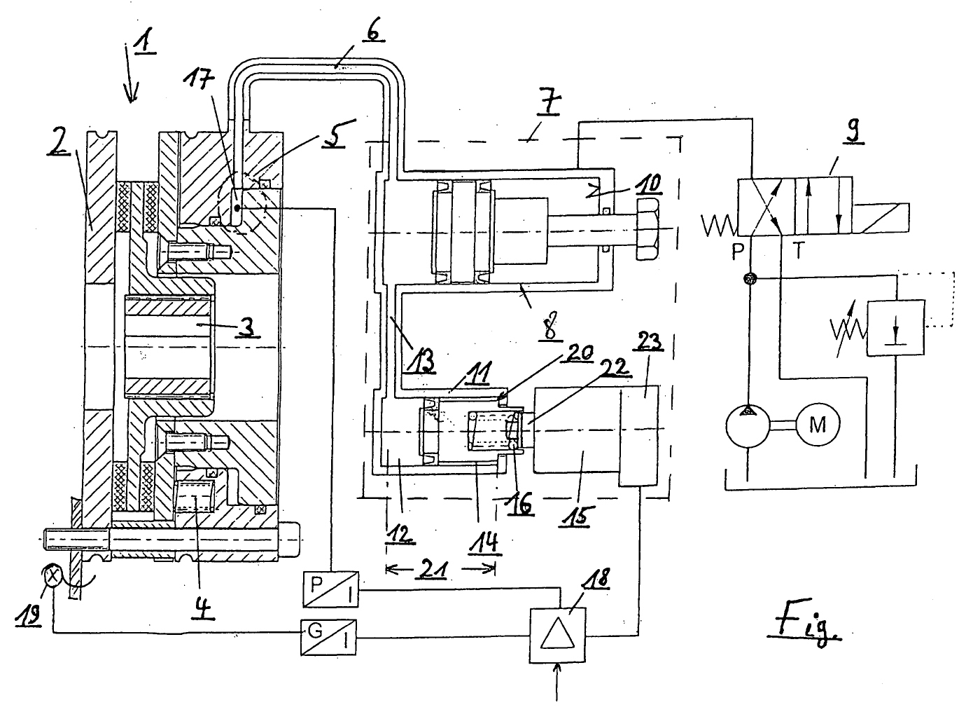

FIG. 1 shows a first exemplary embodiment of the invention.

The FIGURE shows a safety brake 1.

Such safety brakes comprise a stationary brake stator 2 and a brake rotor 3, which is rotatably mounted relative to the brake stator.

Located between the brake rotor and the brake stator are the brake pads, depicted by diagonal hashing.

Serving as the power booster 4 are compression springs by means of which the axially displaceable brake stator is pressed against the brake pads of the brake rotor to bring the brake rotor 3 to a stop under the respective load torque.

The function of moving from the thus-reached brake applied position back to the brake released position is performed by a piston-cylinder unit 5, which is connected via a pressure medium line 6 to a booster system 7.

It is essential that the booster system 7 comprises two mutually separate piston-cylinder units 8, 11.

In addition to the purely hydraulic piston-cylinder unit 8, which is driven purely hydraulically on its intake and discharge sides, an additional piston-cylinder unit 11 is provided.

The hydraulically driven piston-cylinder unit 8 is connected via a direction control valve 9 to a pressure source or a tank, depending on the position of direction control valve 9.

If direction control valve 9 is in the venting position, as shown, the piston of hydraulically driven piston-cylinder unit 8 can travel maximally to rear stop 10; hence, the closed space of piston-cylinder unit 5, which is responsible for displacing the safety brake 1 between the brake applied position and the brake released position, becomes minimal, while at the same time the power boosters 4 assume their maximum extended length.

In deviation herefrom, additional piston-cylinder unit 11 has only one hydraulic side 12, which is also connected, in parallel with the output side of hydraulically driven piston-cylinder unit 8, to pressure medium line 6.

The two piston-cylinder units 8, 11 are therefore disposed in parallel on pressure medium line 6, so that the pressure that prevails in the hydraulic spaces of hydraulically driven piston-cylinder unit 8 and additional piston-cylinder unit 11 is consistent with that which is present in pressure medium line 6.

This purpose is served by a communicating connecting line 13 between the pressure space of hydraulically driven piston-cylinder unit 8 and the pressure space of additional piston-cylinder unit 11.

On its side facing away from the hydraulic side 12, additional piston-cylinder unit 11 is acted on motorically by a displacing drive 15 that is stably positionable in different positions.

This motoric action on additional piston-cylinder unit 11 therefore brings the piston and the cylinder into a defined relative position that depends on the respective position of displacing drive 15, thereby generating an initial pressure in the pressure medium line 6 that is in equilibrium with the respective deflection of the power boosters 4, as long as the safety brake is not in one of its end positions, the brake released position or the brake applied position.

Complementarily, the FIGURE shows that a compression spring 16 is disposed between displacing drive 15 and additional piston-cylinder unit 11.

The connection between displacing drive 15 and the piston of additional piston-cylinder 11 is therefore a floating connection under the effect of compression spring 16, as long as the piston of additional piston-cylinder unit 11 is not displaced in the direction of a stop integral to the housing by excessive pressure build-up in piston-cylinder unit 8.

The FIGURE further shows that a measuring sensor 17 is provided to detect an operating parameter and that this measuring sensor 17 is integrated into a feedback control loop for modulating displacing drive 15.

To this end, provided between measuring sensor 17 and feedback controller 18, whose output acts on the motoric drive of displacing drive 15, is a converter that converts the output signal from the measuring sensor into a signal suitable for use as an input signal for motoric displacing drive 15.

The measuring sensor illustrated here is a pressure sensor operative to detect the static pressure in pressure medium line 6, which static pressure can be picked up at any location in the communicating system.

It is further indicated that an additional measuring sensor 19 operative to detect an additional operating parameter can be provided.

In this way, additional operating parameters apart from pressure, for example added loads or the like, can be fed into the feedback control loop to control the displacing drive.

Under that assumption, here again the measured value must be converted by a converter into a signal that can be used directly to drive motoric displacing drive 15.

The compression spring 16 is dimensioned in this case such that when the pressure in pressure medium line 6 is lower than the pressure necessary to displace piston-cylinder unit 5 in the direction of the brake released position, additional piston-cylinder unit 11 is held in resiliently supported suspension with very low breakaway torques, whereas the compression spring simultaneously must be designed so that under the pressure necessary to displace piston-cylinder unit 5 in the direction of the brake released position it is compressed to such an extent that additional piston-cylinder unit 11 then comes into abutment.

For this purpose, the rear wall of the cylinder of additional piston-cylinder unit 11 forms a rear stop 20 for the piston, which is inevitably displaced to the right under these circumstances, so feedback control of the hydraulic variables is disregarded in this operating case.

Alternatively, for this purpose the compression spring can also be dimensioned such that its individual coils then form a “block.”

To this end, FIG. 1 shows that the piston of additional piston-cylinder unit 11 is preferably held in a floating position within a given range 21, such that due to the smaller structural size of additional piston-cylinder unit 11 compared to the structural size of hydraulically driven piston-cylinder unit 8, lower breakaway torques can be expected along with small deflections from the respective position, the overall result being that sensitive feedback control is able to take place.

It is further shown that displacing drive 15 is provided with an electric drive (not identified in more detail) that acts via an adjusting spindle 22 on additional piston-cylinder unit 11.

The adjusting spindle and the electromotor drive together constitute a constructional unit in the form of a spindle servomotor.

With regard to operation:

The system is filled with hydraulic fluid and vented out.

The piston of hydraulically driven piston-cylinder unit 8 is in the rearward position, preferably in abutment position.

The piston of additional piston-cylinder unit 11 is immersed a little way into the cylinder by a low initial tension of compression spring 16; this immersed position is the HOME POSITION.

In this position, the safety brake is in the brake applied position.

If the direction control valve 9 is now displaced to the left, the right-hand space of piston-cylinder unit 8 comes under pressure via the pressure line from the pump, and the associated piston is displaced to the left.

Beyond a given pressure, compression spring 16 is compressed to an extent such that either it forms a block or the piston of additional piston-cylinder unit 11 abuts rear stop 20 on the housing.

The brake is then charged with air, i.e., the brake applied position is cancelled and the load is able to move again.

The sensors 17, 19 thereupon report the current set points to the feedback controller 18, so that action is then taken via the spindle servomotor 23 to affect the initial tension of the compression spring 16 and thus the system as a whole.

To initiate the braking process, if the direction control valve is now displaced back into the illustrated position, i.e. toward the brake applied position, while at the same time the control space of piston-cylinder unit 8 is emptied into the tank, the braking process begins.

The initial tension of the compression spring 16 naturally remains the same during this process, so the force exerted on the brake pads by the power boosters 4 is reduced by a force equivalent deriving from the initial tension of the compression spring 16.

Thus, braking always occurs in dependence on the position of the displacing drive 15.

This function is preserved even in the event of a power failure—a necessity for the operation of the safety brake.

In such cases, the spindle servomotor 23 remains in its last adjusted position even during a power failure, so that braking occurs with the most recent sensor-determined set point under these circumstances as well. In addition, whenever the brake is deactivated the spindle servomotor 23 is moved force-dependently into the position designated as the HOME POSITION, permitting automatic status monitoring of the safety brake by force/distance monitoring.

### LIST OF REFERENCE NUMERALS

1 Safety brake
2 Brake stator
3 Brake rotor
4 Power booster
5 Piston-cylinder unit
6 Pressure medium line
7 Booster system
8 Hydraulically driven piston-cylinder unit
9 Direction control valve
10 Rear stop of 8
11 Additional piston-cylinder unit
12 Hydraulic side of 11
13 Connecting line of 5, 8, 11
14 Side of 11 facing away from hydraulic side 12
15 Displacing drive
16 Compression spring
17 Measuring sensor (P)
18 Feedback controller
19 Additional measuring sensor (G . . . )
20 Rear stop of 11
21 Range of floating positions
22 Adjusting spindle
23 Spindle servomotor

1. A safety brake (1) for exerting a braking torque defined by a force exerted by a power booster (4) to reach a brake applied position, serves in the case of a beginning braking process first to completely cancel out kinetic energy of a load to be braked and then to maintain the load in the braked position, the defined braking torque being variable by means of a relative movement between a brake rotor (3) and a brake stator (2) brought about by the action of pressure on a piston-cylinder unit (5) filled with a pressure medium, for which purpose the piston-cylinder unit (5) is communicatively connected via a pressure medium line (6) to a booster system (7), wherein said booster system (7) comprises a hydraulically driven piston-cylinder unit (8), an additional piston-cylinder unit (11) connected by a hydraulic side (12) thereof, in parallel with said hydraulically driven piston-cylinder unit (8), to the pressure medium line (6), and wherein said additional piston-cylinder unit (11) is able to be acted upon motorically, on its side facing away from said hydraulic side (12), by a displacing drive (15) that is stably positionable in different positions.

2. The safety brake as in claim 1, and further comprising a compression spring (16) disposed between the displacing drive (15) and said additional piston-cylinder unit (11).

3. The safety brake as in claim 1, wherein at least one measuring sensor is provided to detect an operating parameter, and wherein said measuring sensor is integrated into a feedback control loop for modulating the displacing drive (15).

4. The safety brake as in claim 3, wherein a pressure sensor is provided to detect static pressure in the pressure medium line (6).

5. The safety brake as in claim 4, wherein at least one additional sensor is provided to detect an additional operating parameter.

6. The safety brake as in claim 5, wherein said additional sensor serves to detect the at least one of weight torque and load torque of the load to be braked.

7. The safety brake as in claim 2, wherein said compression spring (16) is dimensioned such that when pressure in the pressure medium line (6) is lower than the pressure necessary to displace the piston-cylinder unit (5) in the direction of the brake released position, said additional piston-cylinder unit (11) is held in resiliently supported suspension.

8. The safety brake as in claim 7, wherein said compression spring is dimensioned such that it can be compressed, under pressure necessary to displace the piston-cylinder unit (5) in the direction of the brake released position, to such an extent that said additional piston-cylinder unit (11) butts against a stop (20).

9. The safety brake as in claim 1, wherein the displacing drive (15) is provided with an electric drive that acts on said additional piston-cylinder unit (11) via an adjusting spindle (22).

10. The safety brake as in claim 9, wherein the said electric drive is implemented together with the adjusting spindle as a constructional unit in the form of a spindle servomotor (23).
